(19) United States
(12) Patent Application Publication
(10) Pub. No.: US 2015/0062032 A1
(43) Pub. Date: Mar. 5, 2015

(54) MOBILE COMMUNICATION TERMINAL, SCREEN ADJUSTING METHOD AND STORAGE MEDIUM THEREOF

(71) Applicant: HUIZHOU TCL MOBILE COMMUNICATION CO., LTD., HUIZHOU, GD (CN)

(72) Inventor: Fang Xie, Huizhou (CN)

(21) Appl. No.: 14/389,365

(22) PCT Filed: Mar. 20, 2013
(86) PCT No.: PCT/CN2013/072932

§ 371 Date: Sep. 29, 2014

(30) Foreign Application Priority Data
May 24, 2012 (CN) 201210167296.7

(51) Int. Cl. G06K 9/00; G06F 3/041

(52) U.S. Cl. CPC G06K 9/00033; G06F 3/041
USPC 345/173

(57) ABSTRACT

A mobile communication terminal, a screen adjusting method and a storage medium thereof are provided. The screen adjusting method may include collecting first fingerprint characteristic data and second fingerprint characteristic data. When it is determined that the first fingerprint information is consistent with the second fingerprint information, an angle difference value between a first fingerprint direction and a second fingerprint direction may be calculated. When the angle difference value between the first fingerprint direction and the second fingerprint direction is within a threshold range, a display mode may be switched to a second screen display mode. For example, a user can flexibly perform switching between a horizontal screen display mode and a vertical screen display mode of a mobile communication terminal.

### TECHNICAL FIELD

The present disclosure relates to the field of mobile communication technologies, and in particular, to a mobile communication terminal and a screen adjusting method based on the mobile communication terminal.

### BACKGROUND

With the development of electronic technologies and the reduction of the manufacturing costs of various display screens, the display screens of more and more mobile communication terminals are increasingly larger. The mobile communication terminal of the prior art may switch between a horizontal screen and a vertical screen through a gravity sensor for the mobile communication terminal. The gravity sensor adjusts a display interface by detecting the direction of the earth gravity. For example, when a user reads an e-book through the mobile communication terminal, the gravity sensor built in the mobile communication terminal may detect the rotation of the mobile communication terminal so as to switch the vertical screen mode displayed for the e-book, making it convenient for the user to view. However, in certain circumstances, the user does not need such a display effect. For example, when the user lies on one side, the mobile communication terminal may automatically switch to a horizontal screen, which is contrary to the viewing habit of the user. A user cannot freely switch between the horizontal and vertical screen display modes of the mobile communication terminal, thus causing inconvenience to the user.

A mobile communication terminal and a screen adjusting method, based on the mobile communication terminal, are needed so as to solve the foregoing problems.

### SUMMARY

A mobile communication terminal and a screen adjusting method are provided that allows a user to freely switch between horizontal and vertical screen display modes of the mobile communication terminal.

A mobile communication terminal is provided with a touch screen and having a screen adjusting method. In a first screen display mode, the method includes responding to a selection of a user to provide a user interface of initial setting, detecting a first pressing action of a finger of a user on a user interface, collecting a first fingerprint image in response to the first pressing action, and generating first fingerprint characteristic data based on the first fingerprint image, wherein the first fingerprint characteristic data is representative of first fingerprint information and a first fingerprint direction; detecting a second pressing action of a finger of the user on the user interface, collecting a second fingerprint image in response to the second pressing action, and generating second fingerprint characteristic data based on the second fingerprint image, wherein the second fingerprint characteristic data is representative of second fingerprint information and a second fingerprint direction. The method further includes determining whether the first fingerprint information is consistent with the second fingerprint information, when it is determined that the first fingerprint information is consistent with the second fingerprint information, further calculating an angle difference value between the first fingerprint direction and the second fingerprint direction, and when the angle difference value is within a threshold range, switching to a second screen display mode.

In another embodiment, a mobile communication terminal is provided having a touch screen, a processing module and a switching module. When the touch screen is in a first screen display mode the processing module detects a first pressing action of a finger of a user on a user interface, collects a first fingerprint image in response to the first pressing action, and generates first fingerprint characteristic data based on the first fingerprint image, wherein the first fingerprint characteristic data is representative of first fingerprint information and a first fingerprint direction. The processing module detects a second pressing action of a finger of the user on the user interface, collects a second fingerprint image in response to the second pressing action, and generates second fingerprint characteristic data based on the second fingerprint image, wherein the second fingerprint characteristic data is representative of second fingerprint information and a second fingerprint direction. The processing module further determines whether the first fingerprint information is consistent with the second fingerprint information, when the first fingerprint information is determined to be consistent with the second fingerprint information by the processing module, the processing module further calculates an angle difference value between a first fingerprint direction and a second fingerprint direction, and when the angle difference value is within a threshold range, the switching module controls the touch screen to switch to a second screen display mode.

In a further embodiment, a non-transitory computer-readable medium is provided storing instructions that, when executed by a processor, cause the processor to detect a first pressing action of a finger of a user on a user interface, collect a first fingerprint image in response to the first pressing action, and generate first fingerprint characteristic data based on the first fingerprint image, wherein the first fingerprint characteristic data is representative of first fingerprint information and a first fingerprint direction, detect a second pressing action of a finger of the user on the user interface, collect a second fingerprint image in response to the second pressing action, and generating corresponding second fingerprint characteristic data based on the second fingerprint image, wherein the second fingerprint characteristic data is representative of second fingerprint information and a second fingerprint direction. Execution of the instructions further cause the processor to determine whether the first fingerprint information is consistent with the second fingerprint information, when it is determined that the first fingerprint information is consistent with the second fingerprint information, further calculate an angle difference value between the first fingerprint direction and the second fingerprint direction, and when the angle difference value is within a threshold range, switching to a second screen display mode.

The mobile communication terminal acquires first fingerprint characteristic data and second fingerprint characteristic data. When it is determined that the first fingerprint information is consistent with the second fingerprint information, and an angle difference value is within a threshold range, the mobile communication terminal switches to a second screen display mode. Thereby, a user of an associated mobile communication terminal can freely switch between horizontal and vertical screen display modes of the mobile communication terminal, thus improving the experience effect of the user.

### BRIEF DESCRIPTION OF DRAWINGS

FIG. 1 depicts an example structural schematic diagram of a first embodiment of a mobile communication terminal;

FIG. 2 depicts an example structural schematic diagram of a processing module in FIG. 1; and

FIG. 3 depicts a flow chart of an example screen adjusting method.

### DETAILED DESCRIPTION

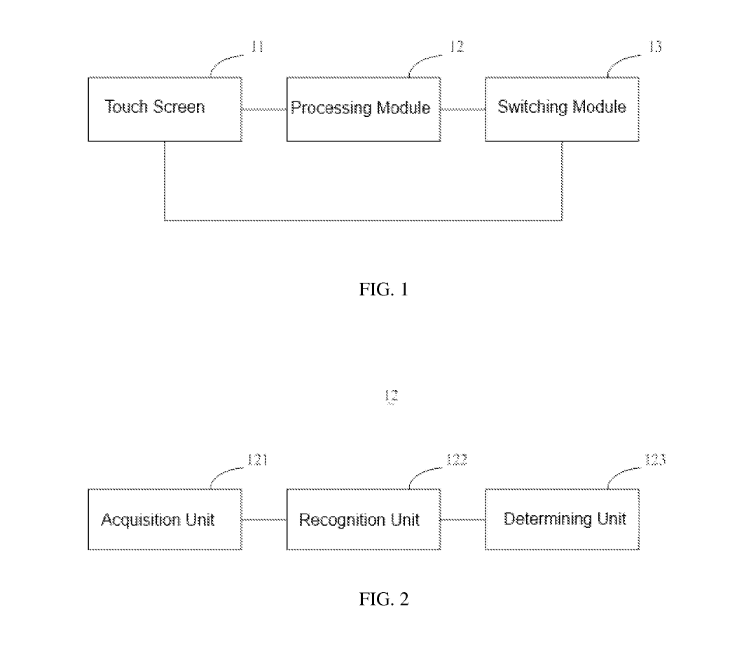

With reference to FIG. 1, a structural schematic diagram of a first embodiment of a mobile communication terminal is depicted. As shown in FIG. 1, the mobile communication terminal 10 may include a touch screen 11, a processing module 12 and a switching module 13.

When the touch screen 11 is in a first screen display mode, the touch screen 11 may respond to a selection of a user to provide a user interface of initial setting. At this time, the processing module 12 may detect a first pressing action of a finger of the user on the user interface from the touch screen 11, may collect a first fingerprint image of a finger of the user on the touch screen 11 in response to the first pressing action, and may generates first fingerprint characteristic data based on the first fingerprint image, wherein the first fingerprint characteristic data may be representative of first fingerprint information and a first fingerprint direction.

When the touch screen 11 provides an application interface, the user may carry out a second pressing action on the user interface. At this time, the processing module 12 may detect a second pressing action of a finger of the user on the user interface from the touch screen 11, may collect a second fingerprint image of a finger of the user on the touch screen 11 in response to the second pressing action, and may generates second fingerprint characteristic data in response to the second fingerprint image, wherein the second fingerprint characteristic data may be representative of second fingerprint information and a second fingerprint direction.

The processing module 12 may compare the first fingerprint information with the second fingerprint information. When the first fingerprint information is determined to be consistent with the second fingerprint information, the processing module 12 may further calculate an angle difference value θ between the first fingerprint direction and the second fingerprint direction, and when the angle difference value θ is within a threshold range, the switching module 13 may control the touch screen 11 to switch to a second screen display mode.

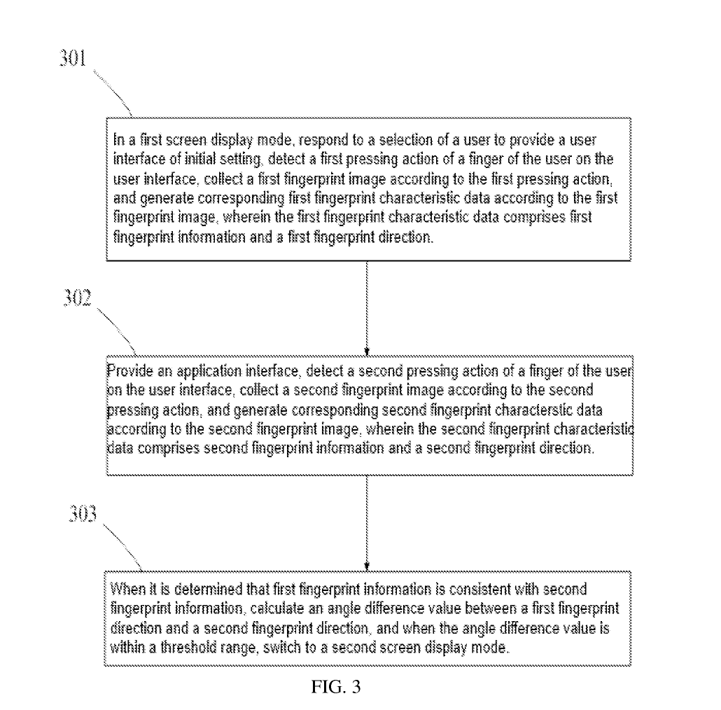

Turning to FIG. 2, a structural schematic diagram of a processing module in FIG. 1 is depicted. As shown in FIG. 12, the processing module 12 may include an acquisition unit 121, a recognition unit 122 and a determining unit 123.

The acquisition unit 121 may be connected with a touch screen 11 so as to induce and acquire a first pressing action and/or a second pressing action of a user on a touch screen 11 from the touch screen 11, and may send information of the first pressing action and/or the second pressing action to the recognition unit 122. The recognition unit 122 may collect a first fingerprint image and/or a second fingerprint image in response to the first pressing action or the second pressing action, respectively, and may generates first fingerprint characteristic data and/or second fingerprint characteristic data in response to the first fingerprint image or the second fingerprint image, respectively. The determining unit 123 may acquire and determine the first fingerprint characteristic data and/or the second fingerprint characteristic data from the recognition unit 122. When the first fingerprint information is consistent with the second fingerprint characteristic data, and when the angle difference value θ is within a threshold range, the determining unit 123 may send a signal to the switching module 13, so that the switching module 13 may control the touch screen 11 to switch to a second screen display mode.

When a touch screen 11 is in a first screen display mode, a user may touch a touch screen 11 to select an initial setting. The touch screen 11 may display a user interface and a finger of the user may carry out a first pressing action on the user interface. The acquisition unit 121 may acquire the first pressing action through the touch screen 11, and may send information of the first pressing action to the recognition unit 122. The recognition unit 122 may collect a first fingerprint image in response to the first pressing action, and may generate first fingerprint characteristic data base on the first fingerprint image. The user may associate the first fingerprint characteristic data with the first screen display mode through the mobile communication terminal 10, and may save the first fingerprint characteristic data on the determining unit 123 of the mobile communication terminal 10.

When the touch screen 11 displays an application interface, a user may carry out a second pressing action on the user interface. The acquisition unit 121 may acquire the second pressing action through the touch screen 11, and may send information of the second pressing action to the recognition unit 122. The recognition unit 122 may collect a second fingerprint image in response to the second pressing action, and may generates second fingerprint characteristic data based on the second fingerprint image. The determining unit 123 may compare the first fingerprint characteristic data with the second fingerprint characteristic data. When the first fingerprint information is determined to be consistent with the second fingerprint information, the determining unit 123 may further determine whether an angle difference value θ between the first fingerprint direction and the second fingerprint direction is within a threshold range. When the angle difference value θ is within the threshold range, the switching module 13 may control the touch screen 11 to switch to a second screen display mode. In an exemplary embodiment, the first screen display mode may be a vertical screen display mode and the second screen display mode may be a horizontal screen display mode; moreover, the threshold range is between 80 degrees and 100 degrees or between −100 degrees and −80 degrees.

The first screen display mode may be adjusted into a horizontal screen display mode and a second screen display mode may be adjusted into a vertical screen display mode. A threshold range may be set into other values, for example, the threshold range may be set between 85 degrees and 95 degrees or between −95 degrees and −85 degrees.

A mobile communication terminal 10 may acquire first fingerprint characteristic data and second fingerprint characteristic data from a touch screen 11 through a processing module 12, when it is determined that the first fingerprint information is consistent with the second fingerprint information, and the angle difference value is within the threshold range, a switching module 13 may control a touch screen 11 to switch to a second screen display mode, so that a user can freely switch between horizontal and vertical screen display modes of the mobile communication terminal 10, thus improving the experience effect of the user.

With reference to FIG. 3, a flow chart of a screen adjusting method is depicted. As shown in FIG. 3, a screen adjusting method based on the mobile communication terminal may respond to a selection of a user to provide a user interface of initial setting, may detect a first pressing action of a finger of the user on the user interface, may collect a first fingerprint image in response to the first pressing action, and may generate first fingerprint characteristic data based on the first fingerprint image, wherein the first fingerprint characteristic data may be representative of first fingerprint information and a first fingerprint direction.

The method may further detect a second pressing action of a finger of the user on the user interface, may collect a second fingerprint image in response to the second pressing action, and may generate second fingerprint characteristic data based on the second fingerprint image, wherein the second fingerprint characteristic data may be representative of second fingerprint information and a second fingerprint direction. When it is determined that first fingerprint information is consistent with second fingerprint information, the method may calculate an angle difference value between a first fingerprint direction and a second fingerprint direction, and when the angle difference value is within a threshold range, the method may switch to a second screen display mode.

A mobile communication terminal may be a mobile phone, a palm computer, a tablet computer and the like.

A mobile communication terminal and a screen adjusting method based on the mobile communication terminal may acquire first fingerprint characteristic data and second fingerprint characteristic data. When it is determined that the first fingerprint information is consistent with the second fingerprint information, and the angle difference value is within the threshold range, a display may switch to a second screen display mode, so that a user can freely switch between horizontal and vertical screen display modes of the mobile communication terminal, thus improving the experience effect of the user.

A non-transitory computer-readable medium may be provided with instructions stored thereon that, when executed by a processor, may cause the processor to implement a screen adjusting method based on the mobile communication terminal of the foregoing embodiments.

The foregoing descriptions is intended to provide representative embodiments and does is not intended to limit the scope of the appended claims. Any equivalent structure or equivalent flow transformation fall within the scope of the appended claims.

1. A method according to claim 4, wherein the threshold range is between 85 degrees and 95 degrees or between −95 degrees and −85 degrees.

2. The method according to claim 1, wherein the first screen display mode is a vertical screen display mode, and the second screen display mode is a horizontal screen display mode.

3. The method according to claim 1, wherein the first screen display mode is a horizontal screen display mode, and the second screen display mode is a vertical screen display mode.

4. A screen adjusting method for a mobile communication terminal, having a touch screen, the method comprising:
detecting a first pressing action of a finger of a user on a user interface while in a first screen display mode
collecting a first fingerprint image in response to the first pressing action;
generating first fingerprint characteristic data based on the first fingerprint image, wherein the first fingerprint characteristic data is representative of first fingerprint information and a first fingerprint direction;
detecting a second pressing action of a finger of the user on the user interface;
collecting a second fingerprint image in response to the second pressing action;
generating corresponding second fingerprint characteristic data based on the second fingerprint image, wherein the second fingerprint characteristic data is representative of second fingerprint information and a second fingerprint direction;
determining whether the first fingerprint information is consistent with the second fingerprint information,
wherein, when it is determined that the first fingerprint information is consistent with the second fingerprint information, calculating an angle difference value between a first fingerprint direction and a second fingerprint direction, and
wherein, when the angle difference value is within a threshold range, switching to a second screen display mode.

5. The method according to claim 4, wherein the first screen display mode is a vertical screen display mode, and the second screen display mode is a horizontal screen display mode.

6. The method according to claim 5, wherein the threshold range is between 80 degrees and 100 degrees or between −100 degrees and −80 degrees.

7. The method according to claim 4, wherein the first screen display mode is a horizontal screen display mode, and the second screen display mode is a vertical screen display mode.

8. The method according to claim 4, wherein the threshold range is between 80 degrees and 100 degrees or between −100 degrees and −80 degrees.

9. A mobile communication terminal, comprising: a touch screen, a processing module and a switching module;
when the touch screen is in a first screen display mode,
the processing module detects a first pressing action of a finger of a user on a user interface, collects a first fingerprint image in response to the first pressing action, and generates first fingerprint characteristic data based on the first fingerprint image, wherein the first fingerprint characteristic data is representative of first fingerprint information and a first fingerprint direction;
the processing module detects a second pressing action of a finger of the user on the user interface, collects a second fingerprint image in response to the second pressing action, and generates second fingerprint characteristic data based on the second fingerprint image, wherein the second fingerprint characteristic data is representative of second fingerprint information and a second fingerprint direction; and
determining whether the first fingerprint information is consistent with the second fingerprint information,
wherein, when the first fingerprint information is determined to be consistent with the second fingerprint information by the processing module, the processing module further calculates an angle difference value between the first fingerprint direction and the second fingerprint direction, and
wherein, when the angle difference value is within a threshold range, the switching module controls the touch screen to switch to a second screen display mode.

10. The mobile communication terminal according to claim 9, wherein the first screen display mode is a vertical screen display mode, and the second screen display mode is a horizontal screen display mode.

11. The mobile communication terminal according to claim 10, wherein the threshold range is between 80 degrees and 100 degrees or between −100 degrees and −80 degrees.

12. The mobile communication terminal according to claim 9, wherein the first screen display mode is a horizontal screen display mode, and the second screen display mode is a vertical screen display mode.

13. The communication terminal according to claim 12, wherein the threshold range is between 80 degrees and 100 degrees or between −100 degrees and −80 degrees.

14. A non-transitory computer-readable medium storing instructions that, when executed on a processor, cause the processor to:
detect a first pressing action of a finger of a user on a user interface;
collect a first fingerprint image in response to the first pressing action;
generate first fingerprint characteristic data based on the first fingerprint image, wherein the first fingerprint characteristic data is representative of first fingerprint information and a first fingerprint direction;
detect a second pressing action of a finger of the user on the user interface;
collect a second fingerprint image in response to the second pressing action;
generate second fingerprint characteristic data according to the second fingerprint image, wherein the second fingerprint characteristic data is representative of second fingerprint information and a second fingerprint direction; and
determining whether the first fingerprint information is consistent with the second fingerprint information,
wherein, when it is determined that the first fingerprint information is consistent with the second fingerprint information, further calculating an angle difference value between the first fingerprint direction and the second fingerprint direction, and
wherein, when the angle difference value is within a threshold range, switching to a second screen display mode.

15. The non-transitory computer-readable medium according to claim 14, wherein the first screen display mode is a vertical screen display mode, and the second screen display mode is a horizontal screen display mode.

16. The non-transitory computer-readable medium according to claim 14, wherein the threshold range is between 80 degrees and 100 degrees or between −100 degrees and −80 degrees.

17. The non-transitory computer-readable medium according to claim 14, wherein the first screen display mode is a horizontal screen display mode, and the second screen display mode is a vertical screen display mode.

18. The non-transitory computer-readable medium according to claim 17, wherein the threshold range is between 80 degrees and 100 degrees or between −100 degrees and −80 degrees.

19. The non-transitory computer-readable medium according to claim 14, wherein the threshold range is between 85 degrees and 95 degrees or between −95 degrees and −85 degrees.

20. The non-transitory computer-readable medium according to claim 17, wherein the threshold range is between 85 degrees and 95 degrees or between −95 degrees and −85 degrees.
